(19) United States
(12) Patent Application Publication
(10) Pub. No.: US 2007/0029738 A1
(43) Pub. Date: Feb. 8, 2007

(54) MLS gasket sealability with bronze addition

(76) Inventors: Dennis F. Person, Rockford, IL (US); Rohit Ramkumar, Romeoville, IL (US); Frank Grant-Acquah, Hanover Park, IL (US); Frank W. Popielas, Plainfield, IL (US); Thomas P. Plunkett, Plainfield, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/198,499

(22) Filed: Aug. 5, 2005

(51) Int. Cl. F02F 11/00

(52) U.S. Cl. 277/592

(57) ABSTRACT

A composition and method for coating a MLS gasket is disclosed. The coating may include a polymer with bronze particulate. The particulate improves the sealability of a coating on the gasket during operation.

### TECHNICAL FIELD

The present invention relates to coatings for multi-layer steel (MLS) gaskets used in internal combustion engines, and more particularly, to coating compositions for sealing component layers of MLS gaskets used in internal combustion engines with improved sealability.

### BACKGROUND

A recurring challenge faced by designers of internal combustion engines is to maintain a gas-tight seal between the engine block and cylinder head. In recent years, advances in gasket design—notably the introduction of multiple-layered steel (MLS) gaskets—have helped reduce sealing problems associated with the interface between the cylinder head and the engine block.

Conventional MLS gaskets typically comprise an interior steel layer that is sandwiched between a pair of exterior steel layers. The exterior layers are often made of 301 stainless steel, which is a comparatively strong metal having a high spring rate. The interior layer, which is also called a “spacer” layer, is normally made of less expensive materials, such as 409 stainless steel, or in some cases, zinc-plated steel or other low carbon steels.

Like other cylinder head gaskets, MLS gaskets include a number of apertures that extend between the exterior steel layers. When installed between the cylinder head and the engine block, the apertures circumscribe cylinder bores (i.e., combustion apertures), boltholes, and coolant and oil ports. During engine operation, the areas of the gasket adjacent to the cylinder bores are subject to greater stresses than areas of the gasket spaced further away from the combustion apertures. To compensate for the greater stresses, MLS gaskets include stopper layers, which surround each of the combustion apertures.

When compared to other regions of the MLS gasket, the stopper layers provide comparatively higher sealing pressure around the portions of the gasket that border the combustion apertures. In some cases the stopper layers comprise additional layers of metal, which are folded over or under the primary sealing layers (i.e., exterior layers or spacer layer). In other cases, the stopper layers comprise discrete annular rings positioned about the boundaries of the combustion apertures.

Most MLS gaskets also include secondary seals that, relative to the combustion apertures, are located radially outward of the stopper layer. Each of the secondary seals generally comprises an active spring seal that is defined by embossed beads on the external sealing layers. The embossed beads are normally arranged in pairs, so that a bead on one of the exterior layers has a corresponding bead on the opposing exterior layer.

MLS gaskets may also include a coating layer formed on sealing surfaces of one or more of the gasket layers. The coating layer helps improve the seal between the engine cylinder head and block. The coating layer is typically made of thermosetting polymers, such as nitrile butadiene rubber (NBR), fluorinated rubbers, fluoropolymers, and the like, which may be compounded with fillers, plasticizers, antioxidants and other materials that modify the properties and performance of the coating layer.

During engine operation, the coating applied to the embossed beads may undesirably separate and tear due to high sealing pressures and movement associated with the embossed beads within a MLS gasket. This separation is known to degrade gasket life and performance.

Though useful, conventional coatings used on MLS gaskets can be improved. For example, coatings typically have an undesirable lack of resistance to compression, resulting in tearing and separation of the coating around the bead areas. Some coating systems also use primer and anti-stick coatings, which help the coating adhere to the surface of the metal gasket layers while permitting adjacent gasket layers to move relative to one another. However, the additional coating layers add to the cost and complexity of the coating process.

The present invention helps overcome, or at least mitigate one or more of the problems described above.

### SUMMARY OF THE INVENTION

One embodiment of the present invention provides coating for an MLS gasket that includes a polymer and a predetermined amount of bronze particulate dispersed within said polymer.

Another embodiment of the present invention is a MLS gasket that includes a metal layer having a bead portion and a coating applied to at least a portion of the metal layer. A bronze particulate is suspended within the coating.

Yet another embodiment of the present invention provides a method for coating an MLS gasket to improve the sealability for the MLS gasket. The method includes incorporating bronze particulate into a coating and applying the coating to at least a portion of the MLS gasket.

### BRIEF DESCRIPTION OF THE DRAWINGS

FIG. 1 is a fragmentary plan view of a gasket having a coating according to the present invention.

FIG. 2 is a partially exploded sectional view of the gasket, taken along lines 2-2 in FIG. 1.

FIG. 2A is an enlarged view of area 2A of FIG. 2, with the gasket coating thickness exaggerated for clarity.

### DETAILED DESCRIPTION

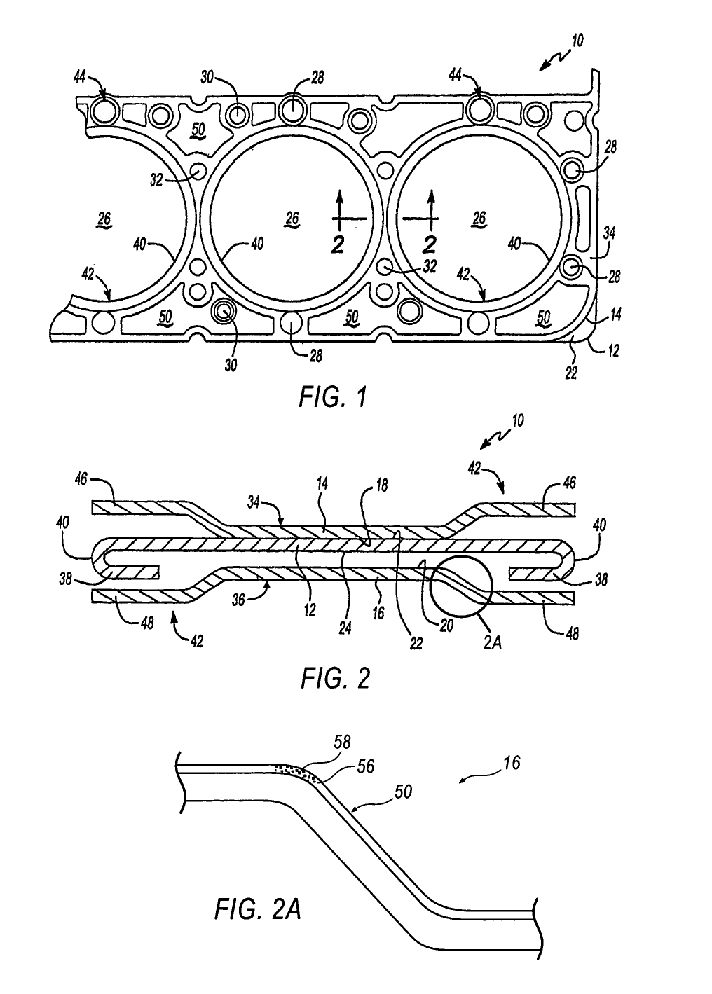

With reference to FIGS. 1 and 2, a MLS gasket 10 includes an interior metal layer 12, which is disposed between a first metal layer 14 and second metal layer 16. When the MLS gasket 10 is installed between an engine cylinder head and block (not shown), inward-facing (first) surfaces 18, 20 of the pair of exterior metal layers 14, 16 abut outward-facing, first 22 and second 24 surfaces of the interior metal layer 12. Preferably, the exterior layers 14, 16 are made of 301 stainless steel, which is a comparatively strong metal having a high spring rate. The interior layer 12, which is also called a “spacer” or “stopper” layer, is preferably made of less expensive materials, such as 409 stainless steel, or in some cases, zinc-plated steel or other low carbon steels. While the MLS gasket 10 has three metal layers, other embodiments may have a different number of layers.

The MLS gasket 10 includes sets of apertures 26, 28, 30, 32 which extend between the outward-facing (second) surfaces 34, 36 of the exterior metal layers 14, 16. One set of apertures 26 circumscribes the combustion cylinders (not shown) of the engine. Another set of apertures 28 provides clearances for threaded fasteners (e.g., bolts) that attach the MLS gasket 10 to the engine block and cylinder head. Other sets of apertures 30, 32 provide passageways for engine coolant, oil, etc.

As noted above, regions of the MLS gasket 10 adjacent to the cylinder bores are subject to greater stresses than portions of the gasket 10 spaced further away from the combustion apertures 26 during engine operation. To compensate for the greater stresses, the MLS gasket 10 includes a stopper layer 38, which surrounds each of the combustion apertures 26. When compared to other regions of the MLS gasket 10, the stopper layer 38 provides comparatively higher sealing pressure around the portions of the gasket 10 that border the combustion apertures 26. As shown in FIG. 2, the stopper layer 38 comprises an additional layer of metal that is formed by folding an edge 40 of the interior layer 12 under the primary sealing layers (i.e., exterior layers 14, 16). In other embodiments, the stopper layer 38 may comprise discrete annular rings positioned about the boundaries of the combustion apertures 26.

The MLS gasket 10 also includes secondary seals 42, 44 that, relative to the combustion apertures 26, are located radially outward of the stopper layer 38. Each of the secondary seals 42, 44 comprises an active spring seal that is defined by embossed beads 46, 48 on the external metal layers 14, 16. The embossed beads 46, 48 are arranged in pairs, so that a bead 46 on one of the exterior layers 14 has a corresponding bead 48 on the opposing exterior layer 16.

As best seen in FIG. 3, one or more of the metal layers 12, 14, 16 includes a resilient coating 50, which is applied on either or both of the first 18, 20, 22 and second surfaces 34, 36, 24 of the layers 12, 14, 16. Coating 50 is illustrated in FIG. 3 directly attached to an outer bead portion 60 of metal layer 16, although coating 50 may be applied to all surfaces of MLS gasket 10. Coating 50 includes a matrix material 56 and a particulate 58. In operation, coating 50 helps seal against the undesired leakage of various fluids, including combustion gases, oil, and coolant from the apertures 26, 28, 30, 32 extending through the MLS gasket 10. In order to provide an affective seal, the coating 50 is chemically resistant to the fluids it encounters, is thermally stable at engine operating temperatures, and exhibits good adhesion to the layers 12, 14, 16.

The thickness and mechanical properties of the coating 50 will depend on the materials of the layers 12, 14, 16, but is typically about 25μ to about 2000μ and more preferably about 500 μl to about 1000μ thick, has a tensile strength greater than about 500 psi, an elongation greater than about 100 percent, and a Shore A hardness between about 45 and about 85.

Preferably, matrix material 56 is a polymer, and, more preferably, a fluoropolymer, such as FKM. Also preferably, particulate 58 is a bronze powder that is suspended in matrix material 56 prior to applying coating 50 onto MLS gasket 10.

A commercial bronze powder that has been found suitable for the application disclosed herein is about 89 to about 91 wt % copper and about 9 to about 11 wt % tin. More preferably, particulate 58 is a bronze powder with a particle maximum dimension of less than 25μ and an aspect ratio of less than about 2. A low aspect ratio allows the particulate 58 to interact within coating 50 in a more predictable and repeatable manner as coating 50 is compressed. As with most commercially available metal powders, particulate 58 may be listed as having a particle size of less than 25μ, and contain some particles with a dimension greater than 25μ.

Preferably, the amount of particulate 58 within said coating is less than about 10 parts per 100 parts of matrix material 56 by weight. More preferably, the amount of particulate 58 within said coating is between about 0.5 parts and about 5 parts per 100 parts of matrix material 56 by weight. While other fillers may be included in the coating 50, it is the ratio of particulate 58 to matrix material 56 that is believed to provide the benefits described herein.

The matrix material 56, which is preferably applied on the layers 12, 14, 16 in a fluid state with particulate 58 dispersed therein, and then solidified in situ, may comprise a blend of one more or reactive coating precursors that are subsequently polymerized and/or cross-linked. Here, “reactive” means that the components of the matrix material 56 react with one another or self-react to cure (solidify); such materials are also referred to as thermosetting resins. Depending on the type of reactive components employed, the matrix material 56 can be cross-linked and/or polymerized using any number of mechanisms, including oxidative curing, moisture curing, thermal curing, high energy radiation curing (e.g., ultraviolet curing, electron beam curing), condensation and addition polymerization, and the like. When a fluoropolymer is used as for the coating, a thermal cure is preferred.

Matrix material 56 can be applied to metal layers 12, 14, 16 using coating techniques known to persons of ordinary skill in the art, including roller coating, dipping, brushing, spraying, stenciling, silk screen printing, and the like. However, of these coating techniques, silk screen printing is preferred because of its low cost, speed, and accuracy. The coating precursors may be applied as a cover-all coating or in a selected continuous or discontinuous pattern depending on the sealing requirements of the application. Specifically, the particulate 58 has been demonstrated to reduce extrusion or movement of coating 50 at the outer bead portions 60 of metal layers 14, 16.

Particulate 58 is believed to increase the sealablity of coating 50 by directly preventing the matrix material 56 from overcompressing as a cylinder head is torqued onto an engine block with MLS gasket 10 interposed therebetween. Therefore, it is believed particulate 58 improves the performance of coating 50 by redistributing the load when coating 50 is compressed to improve sealablity. It is believed that a pure copper or other soft metal powder would deform an undesirable amount and not provide the benefits that bronze particles were discovered to provide.

Typically, a coating without a particulate 58 experiences undesirable separation and tearing at the outer bead portions during prolonged operation. As particulate 58 interacts within the coating 50 between MLS gasket 10 and a cylinder head or an engine block, adjacent outer bead portion 60, the coating 50 is believed to be restrained from separation and allowed to slide as opposed to extrude or move. Accordingly, the MLS gasket sealability is improved. It is also believed that the particulate 58 provides some anti-fretting properties.

The coating precursors may contain additives such as fillers, pigments, defoamers, flattening agents, wetting agents, slip aids, stabilizers, plasticizers, air-release agents, and the like. The additives can be reactive or non-reactive, but are typically non-reactive. Examples of useful non-reactive air-release agents include polydimethyl siloxanes, such as various DC-series silicone oils commercially available from Dow Corning, and SAG 47, which is commercially available from OSI Specialties. Typically, such additives (including air-release agents) are used in amounts necessary to achieve the requisite coating characteristics.

Each of the reactive coating precursors can be applied using coating techniques known to persons of ordinary skill in the art, including roller coating, dipping, brushing, spraying, stenciling, screen printing, and the like. However, of these coating techniques, screen printing is preferred because of its low cost, speed, and accuracy. The coating precursors may be applied to one or both sides of the MLS gasket 10 layers 12, 14, 16 and as a cover-all coating or, as depicted in FIG. 1, in selected continuous or discontinuous patterns depending on the sealing requirements of the MLS gasket 10.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled. The disclosures of all articles and references, including patent applications and publications are incorporated herein by reference for all purposes.

I claim:

1. A coating for an MLS gasket comprising:
a polymer; and
a predetermined amount of bronze particulate dispersed within said polymer.

2. The coating of claim 1, wherein the coating further includes a fluoropolymer.

3. The coating of claim 2, wherein said fluoropolymer is an elastic fluoropolymer.

4. The coating of claim 1, wherein the amount of said bronze particulate within said coating is less than about 10 parts per 100 parts of polymer by weight.

5. The coating of claim 1, wherein the amount of said bronze particulate within said coating is between about 0.5 and 5 parts per 100 parts of polymer by weight.

6. The coating of claim 1, wherein said bronze particulate has a particle size of less than about 25 microns.

7. The coating of claim 1, wherein said bronze particulate has a low aspect ratio.

8. The coating of claim 1, wherein said bronze particulate is about 89 to about 91 percent copper, with the remainder consisting of tin and impurities.

9. An MLS gasket with improved sealability comprising:
a metal layer having a bead portion;
a coating applied to at least a portion of said metal layer; and
a bronze particulate suspended within said coating.

10. The MLS gasket of claim 9, wherein said coating comprises at least one polymer.

11. The MLS gasket of claim 9, wherein said bronze particulate has a particle size of less than about 25 microns.

12. The MLS gasket of claim 9, wherein said bronze particulate has a low aspect ratio.

13. The MLS gasket of claim 9, wherein said bronze particulate is about 89 to about 91 percent copper, with the remainder consisting of tin and impurities.

14. The MLS gasket of claim 10, wherein the amount of said bronze particulate within said coating is less than about 10 parts per 100 parts of polymer by weight.

15. The MLS gasket of claim 10, The coating of claim 1, wherein the amount of said bronze particulate within said coating is between about 0.5 and 5 parts per 100 parts of polymer by weight.

16. The MLS gasket of claim 9, wherein said coating is applied to said bead portion.

17. A method of improving the sealability of a coating for a MLS gasket comprising the steps of:
incorporating bronze particulate into a coating; and
applying said coating to at least a portion of the MLS gasket.

18. The method of claim 17, further comprising the steps of:
preparing a polymer precursor; and
applying said precursor to at least a portion of the MLS gasket

19. The method of claim 18, further comprising the step of curing said precursor to form said coating on said metal gasket.

20. The method of claim 18, wherein the step of curing includes thermal curing.

21. The method of claim 18, further comprising the step of mixing said bronze particulate into said precursor.

22. The method of claim 18, wherein said coating is applied to a bead region of the metal gasket.

23. The method of claim 18, wherein the amount of said bronze particulate within said coating is less than about 10 parts per 100 parts of polymer by weight.
